(19) United States
(12) Patent Application Publication
(10) Pub. No.: US 2017/0352261 A1
(43) Pub. Date: Dec. 7, 2017

(54) REMOTE VEHICLE DATA COLLECTION SYSTEM

(71) Applicants: TOYOTA JIDOSHA KABUSHIKI KAISHA, Toyota-shi, Aichi-ken (JP); DENSO CORPORATION, Kariya-city, Aichi-pref. (JP)

(72) Inventor: Takuya HASEGAWA, Obu-shi, Aichi-ken (JP)

(73) Assignees: TOYOTA JIDOSHA KABUSHIKI KAISHA, Toyota-shi, Aichi-ken (JP); DENSO CORPORATION, Kariya-shi, Aichi-ken (JP)

(21) Appl. No.: 15/536,442

(22) PCT Filed: Nov. 20, 2015
(86) PCT No.: PCT/JP2015/005800

§ 371 Date: Jun. 15, 2017

(30) Foreign Application Priority Data
Dec. 19, 2014 (JP) 2014-257469

(51) Int. Cl. G08G 1/01; G06K 9/46; G07C 5/00; G06K 9/00

(52) U.S. Cl. CPC G08G 1/0112; G08G 1/0133; G08G 1/0129; G06K 9/00798; G06K 9/4671; G07C 5/008

(57) ABSTRACT

A center prescribes, to a subject vehicle, a collection condition for vehicle data through wireless communication. An instruction executing section reads in and executes an instruction described as the collection condition. A determination section determines whether environment information prescribed by the collection condition agrees with the vehicle environment of the subject vehicle. A communication section delivers, to the center, the vehicle data of a time at which the agreement is established.

### TECHNICAL FIELD

The present disclosure relates to a remote vehicle data collection system that remotely collects vehicle data in response to a request via a center.

### BACKGROUND ART

Conventionally, the system disclosed in Japanese Laid-Open Patent Publication No. 2006-283651 is known as such a system. The center of the system prescribes, to a vehicle in advance, transmission conditions for transmitting vehicle data to the center. The data transmission buffer of the vehicle stores the vehicle data when the prescribed transmission conditions are met in the vehicle. Then, the vehicle transmits, to the center, the vehicle data stored in the data transmission buffer either periodically or in response to a request from the center.

### CITATION LIST

### Patent Literature

PLT 1: Japanese Laid-Open Patent Publication No. 2006-283651

### SUMMARY

### Technical Problem

In the system disclosed in Patent Document 1, for example, when collecting vehicle data under a specific vehicle environment such as a lane change, the transmission conditions that correspond to the vehicle environment need to be specific. The transmission conditions include variables representing the environment and conditional expressions. However, in reality, it is difficult to quickly respond to such demands.

Accordingly, it is an objective of the present disclosure to provide a remote vehicle data collection system that readily and quickly collects vehicle data under a specific vehicle environment.

### Means for Solving the Problems

To achieve the foregoing objective and in accordance with one aspect of the present disclosure, a remote vehicle data collection system including a center is provided. The center manages traveling information of a plurality of vehicles. The center prescribes, to a subject vehicle, a collection condition for vehicle data through wireless communication. In the subject vehicle, vehicle data is collected based on the collection condition. The center is configured to read the vehicle data collected in the subject vehicle through wireless communication. The remote vehicle data collection system includes, in the subject vehicle, an instruction executing section, a determination section, and a communication section. The instruction executing section is configured to read in and execute an instruction described as the collection condition. The collection condition is interpreted as the instruction executing section executes the instruction, and the collection condition prescribes environment information. The determination section makes determination on whether the environment information prescribed by the collection condition agrees with a vehicle environment of the subject vehicle. The communication section is configured to deliver, to the center, the vehicle data of a time at which the determination section determines that the agreement is established.

With the above configuration, when the center transmits and prescribes, to the subject vehicle, the collection condition for vehicle data, the instruction that is described as the collection condition is executed in the subject vehicle. Further, it is determined whether the environment information prescribed by the collection condition agrees with the vehicle environment of the subject vehicle. The vehicle data when the agreement is determined to be established is transmitted to the center from the subject vehicle. Since the determination on the vehicle environment made in the subject vehicle, the center is capable of collecting desired vehicle data without specifying variables and conditional expressions that serve as the collection condition. Accordingly, vehicle data under a specific vehicle environment can be readily and quickly collected.

In the above described remote vehicle data collection system, the vehicle data is preferably accumulated in correspondence with the environment information, and a criterion for the environment information is preferably determined in advance through statistical processing performed on the accumulated vehicle data. Further, the determination section is preferably configured to apply the criterion to newly obtained vehicle data to determine whether the environment information agrees with the vehicle environment of the subject vehicle.

With the above configuration, the criterion for environment information is determined in advance through statistical processing performed on the vehicle data accumulated in correspondence with the environment information. It is thus possible to determine whether the environment information prescribed by the collection condition agrees with the vehicle environment of the subject vehicle. If the criterion for environment information is updated in accordance with accumulation of vehicle data in correspondence with the environment information, accuracy of determination of the vehicle environment is improved.

In the above described remote vehicle data collection system, vehicle data is preferably accumulated in the subject vehicle, and the criterion is preferably determined based on the vehicle data accumulated in the subject vehicle. The vehicle data in correspondence with the environment information may be accumulated, for example, at the center. However, in the above configuration, in which the subject vehicle accumulates the vehicle data, the criterion is determined by using the vehicle data that represents the actual condition of the respective vehicles. This further improves accuracy of determination on the vehicle environment.

In the above described remote vehicle data collection system, the subject vehicle preferably includes a vehicle mounted camera, which is configured to capture an image outside or inside the vehicle, and the determination section is preferably configured to use an image captured by the vehicle mounted camera to determine whether the environment information agrees with the vehicle environment of the subject vehicle.

With the above configuration, since detailed information is obtained from the image captured by the vehicle mounted camera, accuracy of determination on the vehicle environment in which the subject vehicle is situated is improved.

In the above described remote vehicle data collection system, the determination section preferably includes an image processing section, which is configured to process an image captured, from outside, by the vehicle mounted camera, and the image processing section is preferably configured to process the image to determine whether the environment information agrees with the vehicle environment of the subject vehicle.

With the above configuration, the image processing section, which has a sufficient processing power for processing images captured by the vehicle mounted camera, is used make determination on the vehicle environment. Therefore, even if image data having a great amount of information is used as input information, a sufficient processing speed of determination on the vehicle environment is ensured.

In the above described remote vehicle data collection system, the subject vehicle preferably includes a plurality of vehicle mounted control devices, which are connected to a controller area network, and the vehicle mounted control devices are preferably configured to collect the vehicle data through communication specified by the CAN protocol.

With the above configuration, vehicle data can be collected from the vehicle mounted control devices by using the versatile CAN protocol, which is widely used in vehicles.

### BRIEF DESCRIPTION OF DRAWINGS

FIG. 1 is a block diagram schematically showing a remote vehicle data collection system according to one embodiment;

FIG. 2 is a graph showing the setting of a criterion with which a support vector machine (SVM) determines whether there has been a lane change;

FIG. 3 is a diagram showing an example of the content of prescriptions on the information collection table;

FIG. 4 is a flowchart of a process for making determination on the vehicle environment that is performed by a control device, which is an image processing ECU, when the remote vehicle data collection system of the embodiment collects vehicle data.

### DESCRIPTION OF EMBODIMENTS

A remote vehicle data collection system according to one embodiment will now be described with reference to the drawings.

The present embodiment includes subject vehicles, a center that manages traveling information of the vehicles, and an externa terminal, which is operated, for example, by an engineer to instruct collection of vehicle data from the vehicles via the center. The external terminal is connected to the center, for example, via an Internet connection and allows a collection condition for vehicle data from the vehicles to be input to the center. The collection condition for vehicle data is preferably set with a lot of flexibility. In the present embodiment, such highly flexible setting of the collection condition is achieved through inputting of scripts. Scripts refer to strings that describe commands to be executed when vehicle data is collected. When a script input through the external terminal is delivered to a vehicle via the center through wireless communication, commands (instructions) described in the delivered script are executed in the vehicle, so that each vehicle collects vehicle data based on the condition described in the script. Thereafter, the collected data is transmitted to the center through wireless communication, and the transmitted vehicle data is transferred to the external terminal via the center.

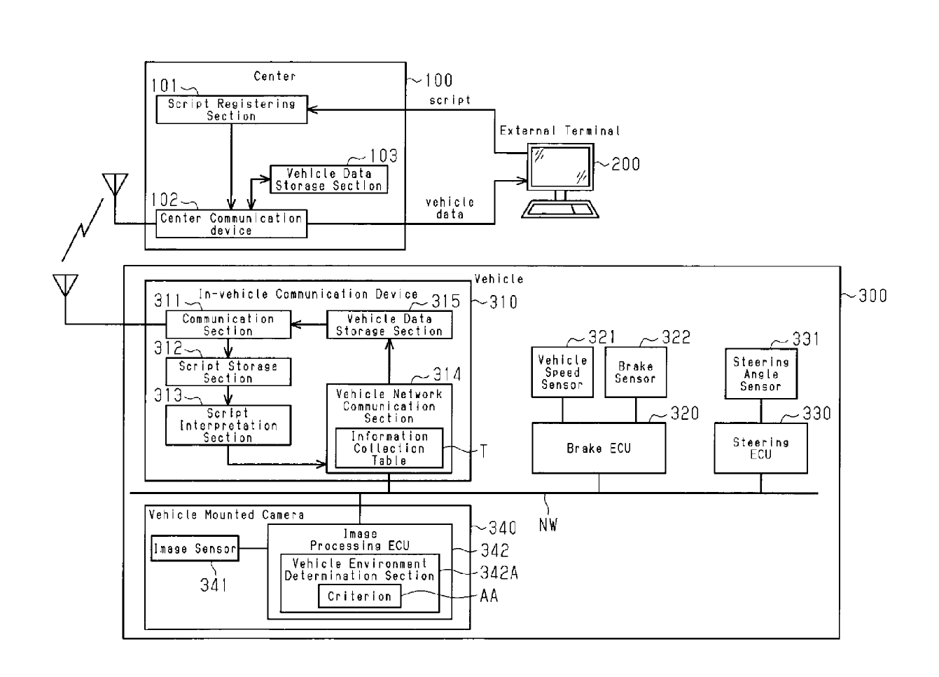

Specifically, as shown in FIG. 1, a center 100 includes a script registering section 101, which registers scripts input through an external terminal 200. In the present embodiment, a script is capable of describing the following items (a) to (e).

(a) Conditional expressions, which include a conditional expression for assessing the vehicle inside environment and a conditional expression that is related to expected situations and is used for identifying the vehicle outside environment;

(b) A checking cycle, at which it is determined whether the vehicle data satisfies a conditional expression and images are classified according to the type of scene and checked;

(c) A data collecting period from the start of data collection to the end;

(d) A sampling cycle, at which data is collected into the storage; and

(e) Vehicle data, which includes CAN data to be collected and values inside ECUs.

The vehicle inside environment that can be described by conditional expressions of the above item (a) includes brake failure and battery voltage drop. The vehicle outside environment that can be described by conditional expressions of the above item (a) includes a lane change, traffic congestion, an accident, a great number of traversers, a great number of parked vehicles, driving on beach, and no traffic congestion. The center 100 composes outbound messages containing scripts registered in the script registering section 101 and wirelessly transmits the composed messages to a vehicle 300 via a center communication device 102. Each section of the center 100 can be configured by various kinds of circuitry.

The vehicle 300 includes an in-vehicle communication device 310, which wirelessly transmits and receives various kinds of information including the outbound message to and from the center 100. When receiving a message sent from the center 100 via a communication section 311, the in-vehicle communication device 310 extracts a script from the received message and temporarily stores the script in a script storage section 312. The in-vehicle communication device 310 then inputs the stored script to a script interpretation section 313. The script interpretation section 313 sequentially reads and executes the instructions in the script, thereby collecting vehicle data based on prescribed conditions via a vehicle network communication section 314. That is, the script interpretation section 313 is an instruction executing section, which is configured to read in and execute instructions described as collection conditions. Each section of the in-vehicle communication device 310 can be configured by various kinds of circuitry.

The vehicle network communication section 314 is connected to vehicle ECUs, which control operations of various vehicle-mounted devices, via a vehicle network NW, which is formed, for example, by a CAN. The vehicle ECUs include, for example, a brake ECU, which controls operation of the brakes, and a steering ECU 330, which controls, for example, assistance for steering operation. The brake ECU 320 is connected to a vehicle speed sensor 321, which detects the speed of the vehicle 300, and a brake sensor 322, which detects the amount of depression of the brake pedal by the driver. The steering ECU 330 is connected to a steering angle sensor 331, which detects the amount of steering of the steering wheel by the driver.

The vehicle network NW is connected to a vehicle mounted camera 340, which captures outside images the vehicle 300. The vehicle mounted camera 340 includes an image sensor 341, which captures images around the vehicle 300, and an image processing ECU 342, which processes pixel signals delivered by the image sensor 341. That is, the image processing ECU 342 is configured to process outside images captured by the image sensor 341. The brake ECU 320, the steering ECU 330, and the image processing ECU 342 are each a vehicle mounted control device, which can be configured by various kinds of circuitry.

The image processing ECU 342 has an image recognition function for images captured during driving of the vehicle. The image recognition function is designed to recognize various types of vehicle outside environment such as a lane change, traffic congestion, an accident, a great number of traversers, a great number of parked vehicles, driving on beach, and no traffic congestion. For example, if a lane change is set as a subject, the image processing ECU 342 uses, for the image recognition function, local feature amounts according to the scale-invariant feature transform (SIFT) and the speeded up robust features (SURF), which local feature amounts are insulated from the influence of image rotations, illumination changes of images, and changes in the image scale. According to the image recognition function, based on local feature amounts extracted from the images, feature points in the images are tracked and the shift amounts of the tracked feature points are calculated.

The image processing ECU 342 includes a vehicle environment determination section 342A, which makes determination on the vehicle environment, which is a vehicle outside environment, based on a criterion AA by using images captured by the image sensor 341. As one example of the determination method executed by the vehicle environment determination section 342A, a support vector machine (SVM) is employed in the present embodiment. The SVM is an identifying method in which supervisor data that has been classified into two classes is subjected to statistical processing to define a criterion used for identifying the class, and when a piece of unknown data is input, that piece of data is classified based on the defined criterion.

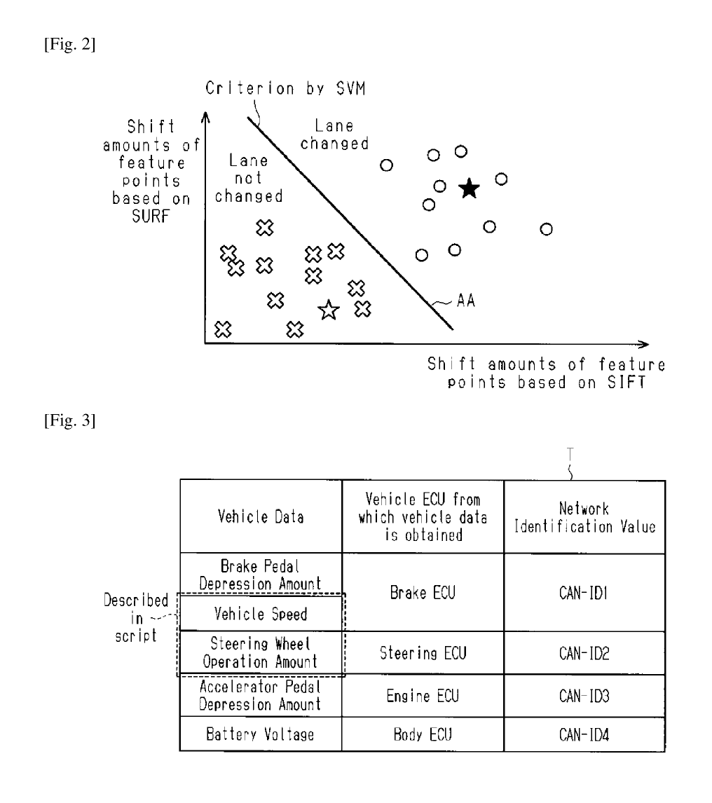

In the graph of FIG. 2, the horizontal axis represents the shift amounts of feature points based on the SIFT extracted from images, and the vertical axis represents the shift amounts of feature points based on the SURF extracted from the images. In the graph, supervisor data related to presence/absence of a lane change, which is a vehicle environment, or a vehicle outside environment, is plotted two-dimensionally. The supervisor data related to a lane change refers to data in which each shift amount that has been extracted in advance by the image processing ECU 342 during driving of the vehicle is associated with presence/absence of a lane change that is determined moment to moment, for example, based on the combination of the white line recognition by the vehicle mounted camera 340 and the amount of steering of the steering wheel, and the data is accumulated, for example, in a writable ROM incorporated in the vehicle environment determination section 342A.

In FIG. 2, pieces of supervisor data obtained when there was a lane change are represented by blank circles, and pieces of supervisor data obtained when there was no lane change are presented by crosses. As shown in FIG. 2, the pieces of supervisor data obtained when there was a lane change form a data group that corresponds to a tendency in which the shift amount of feature points based on the SIFT and the shift amount of feature points based on the SURF are both great. In contrast, the pieces of supervisor data obtained when there was no lane change form a data group that corresponds to a tendency in which the shift amount of feature points based on the SIFT and the shift amount of feature points based on the SURF are both small.

The boundary that separates the pieces of supervisor data obtained when there was a lane change and the pieces of supervisor data obtained when there was no lane change from each other is calculated as a criterion AA by the SVM. After the criterion AA is calculated in this manner, the image processing ECU 342 calculates the shift amount of the feature point based on the SIFT and the shift amount of the feature point based on the SURF from a newly obtained image during the driving of the vehicle 300 in the same manner. The image processing ECU 342 applies the criterion AA to the calculated shift amounts to determine whether there has been a lane change.

Specifically, if the combination of the shift amounts of the feature points in the image newly captured during the driving of the vehicle 300 has a tendency to be greater than the criterion AA as represented by the solid star in FIG. 2, it is determined that the vehicle 300 has changed the lane. If the combination of the shift amounts of the feature points in the image newly captured during the driving of the vehicle 300 has a tendency to be smaller than the criterion AA as represented by the blank star in FIG. 2, it is determined that the vehicle 300 has not changed the lane. Since the determination does not require that the vehicle mounted camera 340 recognizes a white line, a wide variety of road conditions can be dealt with.

As shown in FIG. 1, the vehicle network communication section 314 has an information collection table T, which defines the relationship between vehicle data to be collected and CAN-IDs, which are network identification values of the vehicle ECUs from which the vehicle data is collected.

For example, as shown in FIG. 3, the information collection table T of the present embodiment is associated with the brake ECU, which is a vehicle ECU from which vehicle data such as the vehicle speed and the brake pedal depression amount are obtained. A CAN-ID1, which is a network identification value, is associated with the brake ECU. The information collection table T is also associated with the steering ECU, which is a vehicle ECU from which vehicle data such as the steering wheel operation amount is obtained. A CAN-ID2, which is a network identification value, is associated with the steering ECU.

Thus, in the present example, if a script designates, as the types of vehicle data to be collected, the vehicle speed and the steering wheel operation amount, the vehicle network communication section 314 identifies CAN-ID1 and CAN-ID2 as the network identification values associated with the vehicle data to be collected. The vehicle network communication section 314 identifies the brake ECU and the steering ECU, from which the vehicle data is to be obtained, based on the identified network identification values, and collects vehicle data such as the vehicle speed and the steering wheel operation amount via the vehicle network NW.

As shown in FIG. 1, the vehicle network communication section 314 stores the vehicle data collected via the vehicle network NW in a vehicle data storage section 315. The vehicle data stored in the vehicle data storage section 315 is transmitted to the center communication device 102 from the in-vehicle communication device 310 and is temporarily stored in a vehicle data storage section 103 of the center 100. The vehicle data is then read by the external terminal 200.

As an example of operation of the remote vehicle data collection system of the present embodiment, a process executed when the system collects vehicle data will be described. In this process, the in-vehicle communication device 310 requests a determination on the vehicle environment to vehicle ECUs that are the sources of the environment information described as conditional expressions in a script, which information is the vehicle inside environment information or the vehicle outside environment information. For example, if the script describes a lane change as a conditional expression, the in-vehicle communication device 310 requests the image processing ECU 342, which is capable of determining whether there has been a lane change, to start the determination. If a determination result indicating that the environment information described in the script agrees with the vehicle environment in which the vehicle 300 is situated is delivered to the in-vehicle communication device 310 from the vehicle ECU that has made the determination, the in-vehicle communication device 310 requests the vehicle ECU that is the source of the vehicle data described in the script to collect vehicle data. In contrast, if a determination result indicating that the environment information described in the script does not agree with the vehicle environment in which the vehicle 300 is situated is delivered to the in-vehicle communication device 310 from the vehicle ECU that has made the determination, the in-vehicle communication device 310 does not request collection of vehicle data. Thereafter, the in-vehicle communication device 310 delivers the collected vehicle data to the center 100 when a period that is described as a data collection period in the script has elapsed. That is, a vehicle environment determination section 342A is configured to determine whether the environment information that is prescribed by the collection condition, which is interpreted as an instruction is executed by the script interpretation section 313, agrees with the vehicle environment of the vehicle 300. The communication section 311 is configured to deliver the vehicle data to the center 100 when the vehicle environment determination section 342A determines that the environment information agrees with the vehicle environment.

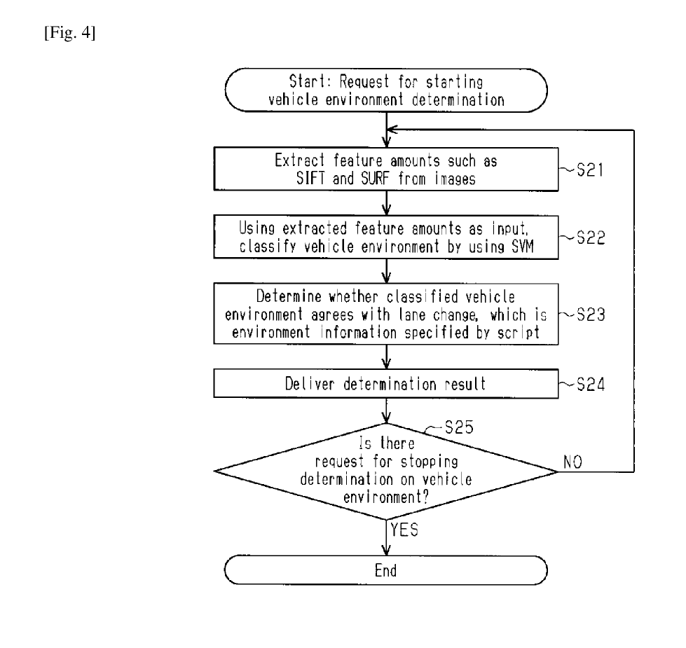

In the above described process for collecting vehicle data, to develop a lane change guiding service, an engineer may describe a lane change as a conditional expression in a script to collect vehicle data at a lane change. The following describes such a case. Specifically, a process will be described in which the image processing ECU 342 makes determination on a vehicle environment related to whether there has been a lane change. In this process, the image processing ECU 342 monitors whether the in-vehicle communication device 310 has requested start of determination on a lane change as the vehicle environment. When there is such a request, the image processing ECU 342 executes the process shown in FIG. 4.

First, the image processing ECU 342 extracts feature amounts, for example, according to SIFT and SURF from images captured during driving of the vehicle 300 (step S21).

Subsequently, using the extracted feature amounts as input, the image processing ECU 342 classifies the vehicle environment in which the vehicle 300 is situated using the SVM (step S22). Based on the criterion AA, which has been defined in advance by the SVM in relation to a lane change, the image processing ECU 342 determines whether the vehicle environment in which the vehicle 300 is situated corresponds to a lane change (step S23). That is, if the script describes a lane change as a conditional expression, the image processing ECU 342 determines whether the vehicle environment in which the vehicle 300 was situated in the previous step S22 corresponded to a lane change. The image processing ECU 342 delivers the determination result to the in-vehicle communication device 310 (step S24).

Subsequently, the image processing ECU 342 determines whether there has been a request for stopping determination on a lane change, which is a vehicle environment prescribed by the in-vehicle communication device 310 (step S25). Until receiving such a request, the image processing ECU 342 repeats steps S21 to S25. Whether there has been a request for stopping the determination is prescribed based on the data collection period in the script. When there is a request for stopping the determination (step S25=YES), the image processing ECU 342 terminates the process shown in FIG. 4.

In the above described process for collecting vehicle data, when the script describes brake failure as a conditional expression, the in-vehicle communication device 310 performs the process described below. In this case, the script describes a sampling cycle that is shorter than the normal cycle and a vehicle speed or the brake pedal depression amount as the vehicle data. That is, if a brake failure occurs in the vehicle 300, the information regarding operation of the brake such as the vehicle speed and the brake pedal depression amount is collected for analysis at a sampling cycle shorter than the normal cycle. During this period, if the vehicle data in the script includes the vehicle speed and the steering wheel operation amount, the brake ECU and the steering ECU are identified from the information collection table T, and the corresponding vehicle data is collected in the above described manner.

As described above, the above described embodiment has the following advantages.

(1) When the center 100 transfers a script to the vehicle 300, instructions described as the script are read and executed in the vehicle 300. In the vehicle 300, it is determined whether the environment information prescribed by the script agrees with the vehicle environment of the vehicle 300. The vehicle data of the time when the agreement is determined to be established is transmitted to the center 100 from the vehicle 300. In this manner, the vehicle environment is determined in the vehicle 300. Thus, even if the center 100 does not specify variables and conditional expressions by using scripts as the collection conditions, desired vehicle data can be collected in the vehicle 300. That is, vehicle data under a specific vehicle environment can be readily and quickly collected.

(2) Whether the environment information agrees with the vehicle environment in which the vehicle 300 is situated is determined through statistical processing performed on the vehicle data accumulated in correspondence with the environment information. That is, the criterion AA for the environment information, which is calculated in advance, is applied to newly obtained vehicle data to determine whether such agreement is established. Thus, if the criterion AA is updated in accordance with accumulation of vehicle data in correspondence with the environment information, accuracy of the determination on the vehicle environment will be improved.

(3) The criterion AA is calculated based on the vehicle data accumulated in the vehicle 300. Thus, since the criterion AA is calculated by using the vehicle data that represents the actual conditions of the respective vehicles, detection accuracy of the vehicle environment is further improved.

(4) The vehicle 300 has the vehicle mounted camera 340, which captures outside images, and the vehicle environment is determined by using images captured by the vehicle mounted camera 340. Thus, since detailed information is obtained from the images captured by the vehicle mounted camera 340, accuracy of determination on the vehicle environment, in which the vehicle 300 is situated, is improved.

(5) The image processing ECU 342, which processes images captured from the outside by the vehicle mounted camera 340, serves as the agent of the determination on the vehicle environment. Thus, the image processing ECU 342, which has a sufficient processing power for processing images captured by the vehicle mounted camera 340, is used to determine the vehicle environment. Therefore, even if image data having a great amount of information is used as input information, a sufficient processing speed is ensured.

(6) The vehicle 300 includes multiple vehicle ECUs, which are connected to each other by the vehicle network NW configured by CAN, and the vehicle data is collected from the vehicle ECUs through communication specified by the CAN protocol. Thus, the vehicle data can be collected from the vehicle ECUs by using the versatile CAN protocol, which is widely used in vehicles 300.

The above described embodiment may be modified as follows.

In the above described embodiment, the agent that makes determination on the vehicle environment may be a vehicle ECU that is different from the image processing ECU 342 and is connected to the vehicle network NW. For example, that different vehicle ECU may accumulate, via the vehicle network NW, the information of feature amounts, for example, according to SIFT and SURF, which are extracted from images by the image processing ECU 342. In this configuration, the different vehicle ECU may calculate a criterion based on the accumulated information and make determination on the vehicle environment such as a lane change.

In the above described embodiment, to predict the vehicle behavior or the outside environment by using only the vehicle data, the vehicle 300 may autonomously collect vehicle data that corresponds to a collection condition prescribed by the script from the center 100. The script from the center 100 prescribes a collection condition that is one of time of a lane change, time of traffic congestion, time of an accident, time of a great number of traversers, and time of a great number of parked vehicles.

In the above described embodiment, to estimate whether the user is feeling comfortable based on vehicle data, the vehicle 300 may autonomously determine to collect vehicle data corresponding to one of time of driving on a road with little congestion, time of driving on an expressway, and time of driving on beach.

In the above described embodiment, to detect an abnormal drop in the battery voltage, the vehicle 300 may collect vehicle data when a drop in the battery voltage is detected.

In the above described embodiment, the center 100 may aggregate vehicle data that has been accumulated for each vehicle in association with vehicle environment. Also, the center 100 may calculate a criterion for vehicle environment based on the aggregated data and distribute the criterion to the respective vehicles. This configuration allows a sufficient number of pieces of vehicle data to be easily used when a criterion is calculated.

In the above described embodiment, the identifying method used for making determination on the vehicle environment is not limited to the SVM, but may be na&iuml;ve Bayes classification or a method using a neural network.

In the above described embodiment, the communication standard of the vehicle network NW, which forms the collection path of vehicle data, is not limited to CAN. At least part of the communication standard of the vehicle network may be another communication standard such as FlexRay (registered trademark) or ethernet.

What is claimed is:

1. A remote vehicle data collection system comprising a center, wherein
the center manages traveling information of a plurality of vehicles,
the center prescribes, to a subject vehicle, a collection condition for vehicle data through wireless communication,
in the subject vehicle, vehicle data is collected based on the collection condition,
the center is configured to read the vehicle data collected in the subject vehicle through wireless communication, the remote vehicle data collection system comprises, in the subject vehicle:
an instruction executing section, which is configured to read in and execute an instruction described as the collection condition, wherein the collection condition is interpreted as the instruction executing section executes the instruction, and the collection condition prescribes environment information,
a determination section, which makes determination on whether the environment information prescribed by the collection condition agrees with a vehicle environment of the subject vehicle, and
a communication section, which is configured to deliver, to the center, the vehicle data of a time at which the determination section determines that the agreement is established.

2. The remote vehicle data collection system according to claim 1, wherein
the vehicle data is accumulated in correspondence with the environment information,
a criterion for the environment information is determined in advance through statistical processing performed on the accumulated vehicle data, and
the determination section is configured to apply the criterion to newly obtained vehicle data to determine whether the environment information agrees with the vehicle environment of the subject vehicle.

3. The remote vehicle data collection system according to claim 2, wherein
vehicle data is accumulated in the subject vehicle, and
the criterion is determined based on the vehicle data accumulated in the subject vehicle.

4. The remote vehicle data collection system according to claim 1, wherein
the subject vehicle includes a vehicle mounted camera, which is configured to capture an image outside or inside the vehicle, and
the determination section is configured to use an image captured by the vehicle mounted camera to determine whether the environment information agrees with the vehicle environment of the subject vehicle.

5. The remote vehicle data collection system according to claim 4, wherein
the determination section includes an image processing section, which is configured to process an image captured, from outside, by the vehicle mounted camera, and
the image processing section is configured to process the image to determine whether the environment information agrees with the vehicle environment of the subject vehicle.

6. The remote vehicle data collection system according to claim 1, wherein
the subject vehicle includes a plurality of vehicle mounted control devices, which are connected to a controller area network, and
the vehicle mounted control devices are configured to collect the vehicle data through communication specified by the CAN protocol.

7. The remote vehicle data collection system according to claim 1, wherein
the center is configured to send a script including at least one of a checking cycle, a data collecting period, a sampling cycle, and data to be collected to the subject vehicle as the collection condition.
